(19) United States
(12) Patent Application Publication
(10) Pub. No.: US 2005/0255731 A1
(43) Pub. Date: Nov. 17, 2005

(54) Terminal adapter and metering device comprising same

(75) Inventors: Fabrizio Biagetti, Livorno (IT); Valerio Polidori, Livorno (IT)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Siemens VDO Automotive SpA.

(21) Appl. No.: 11/188,083

(22) Filed: Jul. 22, 2005

Related U.S. Application Data
(63) Continuation of application No. PCT/EP03/09487, filed on Aug. 27, 2003.

(30) Foreign Application Priority Data
Jan. 24, 2003 (EP) 03001635.6

(51) Int. Cl. H01R 29/00

(52) U.S. Cl. 439/172

(57) ABSTRACT

The invention relates to a terminal adapter (34) for an electrical connector (30) supplying electrical power to a piezoelectric actuator (18) in a high pressure fuel injector (10), in which the axially extendable piezoelectric actuator (18) controls the axial movement of a valve needle (26) to open and close a metering opening of the injector (10). According to the invention, the terminal adapter (34) comprises a set of adapter pins (36) each of which has a first end piece and a second end piece, wherein the first end pieces provide electrical contact to the piezoelectric actuator (18) and the second end pieces are adapted to be connected with an external power supply, and wherein the second end pieces have a flexible bending area allowing axial extensions of the adapter pins.

### CROSS REFERENCE TO RELATED APPLICATION

This application is a continuation of co-pending International Application No. PCT/EP2003/009487 filed Aug. 27, 2003 which designates the United States, and claims priority to European Application Number 03001635.6 filed Jan. 24, 2003.

### TECHNICAL FIELD

The present invention relates to a terminal adapter for an electrical connector supplying electrical power to a piezoelectric actuator in a high pressure fuel injector, in which the axially extendable piezoelectric actuator controls the axial movement of a valve needle to open and close a metering opening of the injector. The invention further relates to a metering device for dosing pressurized fluids comprising such a terminal adapter.

### BACKGROUND

The European Patent application EP 1 046 809 A2 discloses an injection valve of the above mentioned type. As the housing and the piezoelectric actuator are generally fabricated from different materials and have different thermal coefficients of expansion, further measures must be taken to ensure that an injector valve of this type meets the requirements on the fuel flow rate and the geometry of the jet. Particularly important is the influence of the temperature on the principal functional parameters of the injector.

To ensure that the flow rate and other characteristic parameters remain within predetermined limits of tolerance throughout the full range of the operating temperatures from −40° C. to +150° C., the injector valves are typically equipped with a hydraulic thermal compensation unit. As the operation temperature increases, the thermal compensation unit recovers the clearance that would otherwise be created between the valve needle and the piezoelectric actuator.

Due to this fact, the electrical wiring connecting the upper side of the piezoelectric actuator with the outer side of the injector body must likewise permit the axial movements, i.e. the extensions and the contractions of the thermal compensator subgroup with high frequency. At the same time a reliable electrical contact to the piezoelectric actuator must be maintained. In current designs, a bipolar and flexible wire coming out of the injector body provides the electrical connection to the piezoelectric actuator. Such a solution, however, can only be employed for test specimens and is not feasible for the standard mass production of injectors.

### SUMMARY

In view of the foregoing, it is an object of the present invention to provide a contact means adapted to establish good electrical contact between a power supply and a piezoelectric actuator in a high pressure fuel injector while permitting rapid axial movements of a thermal compensator subgroup.

According to the invention, the terminal adapter of the type mentioned above comprises a set of adapter pins, each of which has a first end piece and a second end piece, wherein the first end pieces provide electrical contact to the piezoelectric actuator and the second end pieces are adapted to be connected to an external power supply, and wherein the second end pieces have a flexible bending area allowing axial extensions of the adapter pins.

In a preferred embodiment of the invention, the flexible bending area of the adapter pins is formed in an “L” shape. According to another preferred embodiment, the flexible bending area of the adapter pins may be formed in an “S” shape.

Generally, the flexible bending area of the adapter pins is advantageously formed in a shape permitting an axial extension of the adapter pins of about 100 μm.

These pin shapes are intended to confer an increased compliance to the stiff electrical adapter pins by transforming the tensile stress on the pins arising from the axial oscillations of the thermal compensator in a reduced bending stress on the pins.

According to the invention, a metering device for dosing pressurized fluids, particularly an injection valve for a fuel injection system in an internal combustion engine, comprises a housing having a metering opening, whose opening and closing is controlled by the movement of an axially moveable valve needle. It further comprises an axially extendable piezoelectric actuator cooperating with the valve needle to control its axial movement, a thermal compensator unit cooperating with the piezoelectric actuator and the housing to compensate for different thermal expansion of the housing and the piezoelectric actuator to ensure elastic contact between an end stop of the housing, the piezoelectric actuator and the valve needle, and an electrical connector for supplying electrical power to the piezoelectric actuator. According to the invention, the electric connector comprises a terminal adapter of the type described above.

In a preferred embodiment, the electrical connector contains a set of connector pins rigidly mounted in the body of the electrical connector and adapted to be connected with an external power supply. The connector pins are electrically connected to the second end pieces of the adapter pins, which are then connected to the external power supply via the connector pins.

The second end pieces of the adapter pins are advantageously welded or braised to the connector pins.

The advantages gained by the technical features of the invention include:
an easy assembly of the terminal adapter on the electrical connector and on the injector, avoiding any possible undesired movement of the electrical wiring;
the possibility of using the component easily in high series production; and
no water, gasoline or vapor intrusions are possible.

### BRIEF DESCRIPTION OF THE DRAWINGS

The invention, both its construction an its method of operation together with additional objects and advantages thereof, will best be understood from the following description of specific embodiments when read in connection with the accompanying drawings, wherein

FIG. 1 is a schematic axial cross section of an injector valve with an electrical connector according to an embodiment of the invention;

FIG. 2 is a perspective view of a partly assembled electrical connector according to the invention; and

FIG. 3 shows in (a) and (b) two preferred embodiments of a terminal adapter according to the invention.

### DETAILED DESCRIPTION

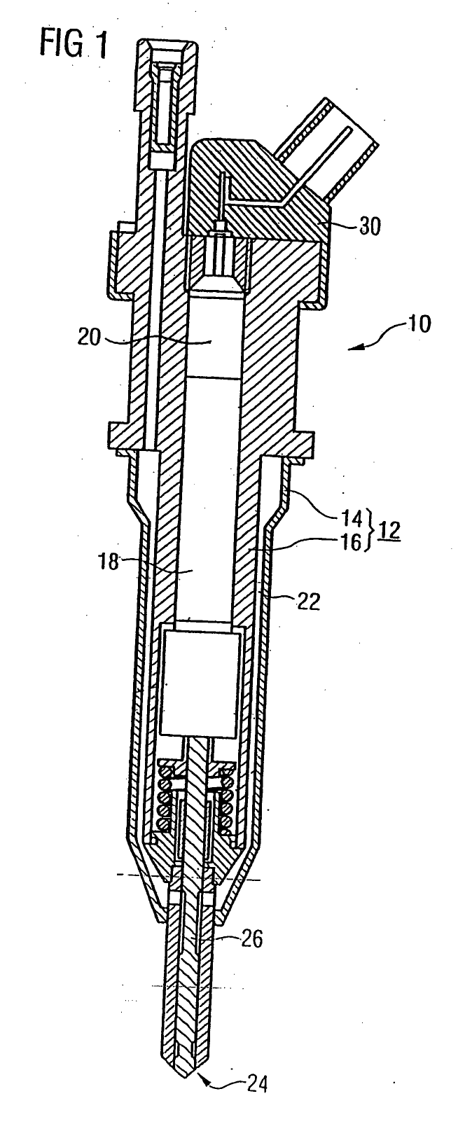

FIG. 1 shows an injection valve for direct-injection gasoline engines, generally designated by 10. The injection valve has a housing 12, which comprises an outer tubular member 14 and an inner tubular member 16. The outer tubular member 14 forms the outer jacket of the injection valve 10, and the inner tubular member 16 contains the piezoelectric actuator 18 and the thermal compensator subgroup 20. The passage 22 formed between the outer tubular member 14 and the inner tubular member 16 provides a large annular pathway which transports the gasoline supplied by an entry duct to gasoline admission holes and into the outlet passage 24 of the injector valve 10.

To open the injection valve 10 to inject gasoline into the engine cylinder, an excitation voltage is applied to the piezoelectric actuator 18 by an electrical connector 30, which is described in detail below. In response to the excitation voltage, the piezoelectric actuator 18 increases in length in axial direction by a predetermined amount, typically about ten or several tens of micrometers. This extension in length is transmitted to a valve needle 26 disposed in the outlet passage 24, which depresses a biasing spring and lifts from its seat. In this position, the injection of pressurized gasoline in the cylinder starts.

When the excitation voltage supplied by the electrical connector 30 is switched off, the length of the piezoelectric actuator 18 in axial direction decreases to its normal value, whereby the biasing pressure of the helical spring forces the valve needle 26 back to its closing position.

A thermal compensator 20 is provided to fix the position of the piezoelectric actuator 18 during fast changes of its length, but compensates for slow changes in the position of the piezoelectric actuator 18 due to, for example, thermal changes.

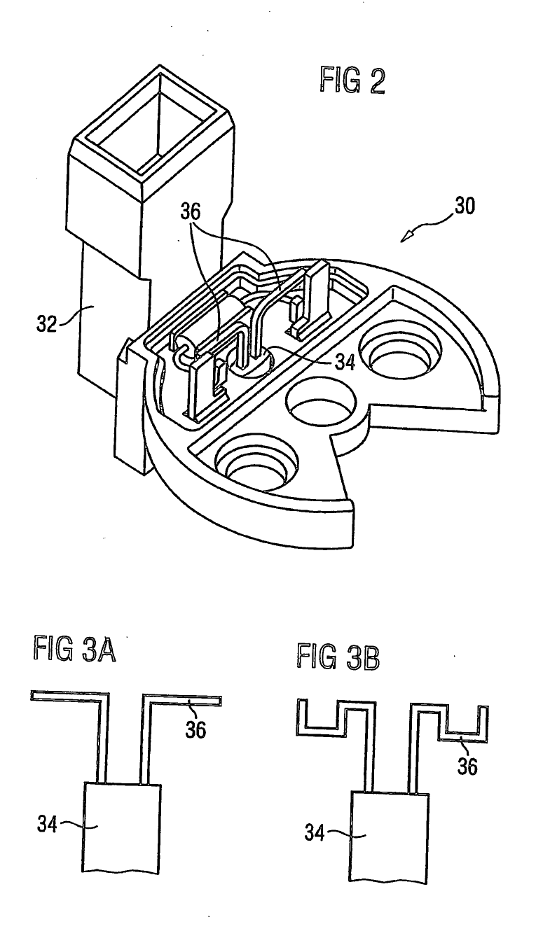

FIG. 2 shows a perspective view of a partly assembled electrical connector 30 according to an embodiment of the invention. The electrical connector 30 has a molded plastic connector body 32 with a terminal adapter 34 comprising a set of adapter pins 36. Each adapter pin 36 has a first end piece (not shown) for providing electrical contact to the piezoelectric actuator 18. Each adapter pin 36 further has a second end piece projecting form the terminal adapter 34 and having an “L”-shape flexible bending area allowing axial extensions of the adapter pins of about 100 μm.

In a later step the second end pieces of the adapter pins 36 are welded or braised to connector pins projecting from the body 32 of the electrical connector 30. In use, the connector pins are connected to an external power supply, whereby electrical power is supplied to the piezoelectric actuator 18 via the connector pins and the adapter pins 36.

The shape of the flexible bending area transforms the tensile stress exerted on the adapter pins by the axial movements of the thermal compensator in a reduced bending stress. Thereby, a stable and reliable electrical contact between the piezoelectric actuator 18, the adapter pins 36 and the connector pins is established permitting axial movements of a thermal compensator subgroup with an amplitude of about 10 μm.

Two specific preferred embodiments of a terminal adapter 34 according to the invention are shown in FIG. 3. FIG. 3 (a) shows a terminal adapter 34 with adapter pins 36 having an “L”-shaped flexible bending area. FIG. 3 (b) shows a terminal adapter 34 whose adapter pins 36 have flexible bending area shaped in the form of the letter “S”.

The features disclosed in the foregoing description, in the drawings, and in the claims may alone as well as in any possible combination be important for the realization of the invention.

1. A terminal adapter for an electrical connector supplying electrical power to a piezoelectric actuator in a high pressure fuel injector, in which the axially extendable piezoelectric actuator controls the axial movement of a valve needle to open and close a metering opening of the injector, comprising a set of adapter pins each of which has a first end piece and a second end piece, wherein the first end pieces provide electrical contact to the piezoelectric actuator, the second end pieces are adapted to be connected to an external power supply, and the second end pieces have a flexible bending area allowing axial extensions of the adapter pins.

2. A terminal adapter according to claim 1, wherein the flexible bending area of the adapter pins is formed in an “L” shape.

3. A terminal adapter according to claim 1, wherein the flexible bending area of the adapter pins is formed in an “S” shape.

4. A terminal adapter according to claim 1, wherein the flexible bending area of the adapter pins is formed in a shape permitting an axial extension of the adapter pins of about 100 μm.

5. A metering device for dosing pressurized fluids, particularly an injection valve for a fuel injection system in an internal combustion engine, comprising:
a housing having a metering opening, whose opening and closing is controlled by the movement of an axially moveable valve needle,
an axially extendable piezoelectric actuator cooperating with the valve needle to control its axial movement,
a thermal compensator unit cooperating with the piezoelectric actuator and the housing to compensate for different thermal expansion of the housing and the piezoelectric actuator to ensure elastic contact between an end stop of the housing, the piezoelectric actuator and the valve needle, and
an electrical connector for supplying electrical power to the piezoelectric actuator comprising a terminal adapter supplying electrical power to the piezoelectric actuator comprising a set of adapter pins each of which has a first end piece and a second end piece, wherein the first end pieces provide electrical contact to the piezoelectric actuator, the second end pieces are adapted to be connected to an external power supply, and the second end pieces have a flexible bending area allowing axial extensions of the adapter pins.

6. A metering device according to claim 5, wherein the electrical connector contains a set of connector pins rigidly mounted in the body of the electrical connector and adapted to be connected with an external power supply, the connector pins being electrically connected to the second end pieces of the adapter pins.

7. A metering device according to claim 5, wherein the second end pieces of the adapter pins are welded or braised to the connector pins.

8. A metering device according to claim 5, wherein the flexible bending area of the adapter pins is formed in an “L” shape.

9. A metering device according to claim 5, wherein the flexible bending area of the adapter pins is formed in an “S” shape.

10. A metering device according to claim 5, wherein the flexible bending area of the adapter pins is formed in a shape permitting an axial extension of the adapter pins of about 100 μm.

11. A piezoelectric actuator comprising:
a terminal adapter (34) for an electrical connector (30) supplying electrical power to the piezoelectric actuator (18) in a high pressure fuel injector (10), wherein the axially extendable piezoelectric actuator (18) controls the axial movement of a valve needle (26) to open and close a metering opening of the injector (10), and
a set of adapter pins (36) each of which has a first end piece and a second end piece, wherein the first end pieces provide electrical contact to the piezoelectric actuator, the second end pieces are adapted to be connected to an external power supply, and the second end pieces have a flexible bending area allowing axial extensions of the adapter pins.

12. A piezoelectric actuator according to claim 11, wherein the flexible bending area of the adapter pins (36) is formed in an “L” shape.

13. A piezoelectric actuator according to claim 11, wherein the flexible bending area of the adapter pins (36) is formed in an “S” shape.

14. A piezoelectric actuator according to claim 11, wherein the flexible bending area of the adapter pins (36) is formed in a shape permitting an axial extension of the adapter pins (36) of about 100 μm.
